(19) United States
(12) Patent Application Publication
(10) Pub. No.: US 2003/0093775 A1
(43) Pub. Date: May 15, 2003

(54) Processing of self-modifying code under emulation

(76) Inventor: Ronald Hilton, San Francisco, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/992,130

(22) Filed: Nov. 14, 2001

(51) Int. Cl. G06F 9/45; G06F 15/76

(52) U.S. Cl. 717/138; 712/41

(57) ABSTRACT

Legacy instructions of a guest system are dynamically emulated on a host system in blocks using block addresses. Detailed translation information is stored in a translation store. Translation indications for a subset of all the translated blocks are stored into a tracking table at block numbers determined by the block addresses. Each particular legacy instruction of a translated block is translated into one or more translated instructions for emulating the particular legacy instruction. If the particular legacy instruction is a store instruction, the indication in the tracking table is checked for the particular block number to determine if instruction data has been stored. If instruction data has been stored for the particular block number, the translation store is checked to determine if instruction data has been modified. If instruction data has not been stored for the particular block number, the checking of the translation store is bypassed adding to the efficiency of the emulation.

### BACKGROUND OF THE INVENTION

The present invention relates to computer systems and particularly to emulation of one computer architecture (the “guest”) via software on the hardware platform of another computer architecture (the “host”).

In typical computer architectures, computer source code is compiled/assembled (at compile/assembly time) into executable object code. The executable object code is executed at execution time on the hardware under control of the operating system. In order for computer source code written for a native architecture to run as a “guest” on a different architecture called a “host” architecture, the host architecture employs an emulator. The emulator emulates the native architecture while actually executing as a guest on the host architecture.

Various methods have been employed for emulating a guest computer architecture via software on the hardware platform of a host computer architecture. The categories of emulation are static emulation and dynamic emulation. In static emulation, the emulation is performed prior to run-time and in dynamic emulation, the emulation is performed at run-time.

One type of static emulation system employs object code translation. The native object code that is compiled/assembled for a native system becomes the guest object code on a host system. The guest object code is translated in a manner that is similar to the way that original source code is compiled/assembled into the object code for the native system. In the emulation case, however, rather than starting with the original source code, the emulation starts with the previously compiled/assembled object code as prepared for the native system. The guest object code (the native object code on the host system) is passed through an emulator to form the translated object code. The translated object code is suitable for execution directly by the host system. Essentially, static emulation is a method of recompiling the native object code without using the original source code. The advantage of such static emulation is that the resulting translated object code can be optimized in much the same way that native object code is optimized when native object code is compiled/assembled from original source code. Unfortunately, it is not always possible to glean all the necessary information statically from the native object code alone that is available when the original source code is compiled/assembled from original source code.

Another method of static emulation is Application Programming Interface (API) mapping. This method of static emulation only applies to operating system code in which the API calls of the guest operating system are mapped to a host call or set of host calls that perform the equivalent function on the host system. The API mapping has a performance advantage since the host operating system software has been optimized for the host system. However, if the native and host systems are too dissimilar, then the desired mapping may not always be possible. Nevertheless, API mapping is a useful method for providing some degree of equivalent operating system functionality when used in conjunction with other forms of static or dynamic emulation.

Dynamic emulation is performed during run time. The main advantage of dynamic emulation is greater transparency to the user in that no pre-processing need be invoked by the user as is required for static emulation. A simple type of dynamic emulation uses an interpreter which fetches, parses, and decodes each guest instruction and responsively executes a routine to carry out the equivalent functions on the host system. The main disadvantage of an interpreter is one of low performance because of the significant overhead involved in processing every guest instruction each time it is executed. To mitigate the disadvantage of that overhead, a more advanced method of dynamic emulation sometimes called “JIT” Just-in-time) translation is employed.

In JIT dynamic emulation, the native object code is translated (similar to the static method), cached, and executed in piecemeal fashion, a small portion at a time. By translating only a small portion of guest object code that is likely to be executed next, the translation is performed in real time, essentially concurrently with the execution of the translated code. The translated code is cached (i.e. saved) to permit subsequent re-use without the need for re-translation. The initial translation overhead is therefore amortized over time, allowing the overall performance to approach that of static object code translation, especially within the most frequently used portions of the code. By using additional information regarding program behavior that can be gleaned at run-time, it is possible to optimize the translated code to obtain performance beyond that achievable with static translation alone.

In order to take advantage of dynamic emulation, there is a need for improved dynamic emulators that help achieve the objectives of improved computer system operation.

### SUMMARY

The present invention is for emulation of a guest computer architecture on a host system of another computer architecture. The guest computer architecture has programs composed of legacy instructions stored at instruction addresses. To perform the emulation of the legacy instructions on the host system, the legacy instructions are accessed in the host system in blocks using the block addresses. Detailed information about the translation of each legacy instruction is stored in a translation store. Also, indications for indicating the translated blocks are stored into an indexing table at block numbers determined by the block addresses. Each particular legacy instruction of a translated block having a particular block number in the table is translated into one or more translated instructions for emulating the particular legacy instruction.

If the particular legacy instruction is a store instruction, the indication in the table is checked for the particular block number to determine if instruction data has been stored. If instruction data has been stored for the particular block number, the translation store is checked to determine if instruction data has been modified. If instruction data has not been stored for the particular block number, the checking of the translation store is bypassed. Since during execution many store instructions do not actually store instruction data, bypassing the checking of the translation store greatly enhances the efficiency of the emulation.

In one preferred embodiment, the step of storing translation indications stores only a subset of all the translated blocks.

In one preferred embodiment, the step of storing translation indications stores into the tracking table using a subset of block address digits whereby multiple blocks have tracking table block numbers that are the same.

In one preferred embodiment, the legacy instructions are for a legacy system having a S/390 architecture.

The foregoing and other objects, features and advantages of the invention will be apparent from the following detailed description in conjunction with the drawings.

### BRIEF DESCRIPTION OF THE DRAWINGS

FIG. 1 depicts a block diagram of a complex of computer systems including a native computer system and a number of computer systems for emulating the native computer system.

FIG. 2 depicts a block diagram of one emulator in the complex of FIG. 1 for emulating the native computer system of FIG. 1.

FIG. 3 depicts an example of one type of dynamic emulation in the FIG. 1 complex.

FIG. 4 depicts an example of improved dynamic emulation used in the FIG. 1 complex.

### DETAILED DESCRIPTION

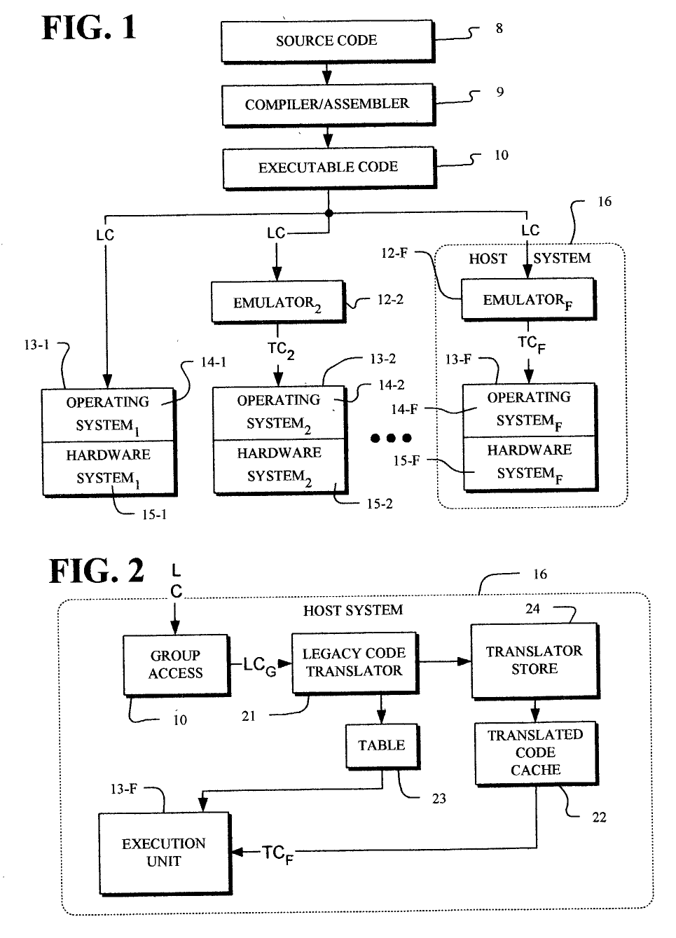

In FIG. 1, a complex of computer systems 13, including computer systems 13-1, 13-2, . . . , 13-F, is presented where the target computer systems 13-2, . . . , 13-F use translated code for emulating the native computer system 13-1. The computer systems 13-1, 13-2, . . . , 13-F are shown in a complex, each receiving the same executable codes. Typically, each of the computer systems 13-1, 13-2, . . . , 13-F is a stand-alone system and not in the same complex. The computer systems 13-1, 13-2, . . . , 13-F are organized as having a operating systems 14-1, 14-2, . . . , 14-F, respectively, and having hardware systems 15-1, 15-2, . . . , 15-F, respectively. In FIG. 1, the host system 16, in a typical embodiment, is a stand-alone system which receives executable legacy code 10 as an input.

For the computer systems 13 of FIG. 1, source code 8, programmed in a convenient language, represents many application and other programs that collectively constitute a large investment in time and knowledge for owners of native computer systems. The native system 13-1 has available well-perfected compilers/assemblers 9 for forming native executable code 11 (legacy code) that efficiently executes application and other programs on the native system 13-1. For the computer systems 13-2, . . . , 13-F, however, well-perfected compilers/assemblers may not be available or, even if available, the source code 8 may not always be available. In order to help preserve the investment in the application and other programs of the native computer system, emulators are employed to execute the executable legacy code on one or more of the target computer systems 13-2, . . . , 13-F. Typically, the target computer systems 13-2, . . . , 13-F are new computer systems that have a different architecture. The objective is to preserve the investment in the application and other programs of the native architecture by enabling them to execute by emulation on the target computer systems.

In FIG. 1, the native executable code 10 is used directly in the computer system 13-1 according to the native architecture which includes a native operating system 14-1 and a native hardware system 15-1. Also, the native executable code 10 is processed by the emulator 12-2 to produce translated code, TC₂, for execution by the target system 13-2 according to an architecture different from the native architecture and which includes an operating system 14-2 and a hardware system 15-2. Similarly, the native executable code 10 is processed by the emulator 12-F to produce translated code, TC_{F}, for execution by the target system 13-F according to an architecture different from the native architecture and which includes an operating system 14-F and a hardware system 15-F.

In FIG. 2, further details of the host system 16 of FIG. 1 are shown. The group access unit accesses legacy code (LC) and presents the legacy code in groups (LC_{G}) to a legacy code translator 21. The legacy code translator 21 stores detailed information about the translation in translation store 24. The legacy code translator 21 also stores the executable blocks of host code in a translated code (TC) cache 23 and indexes the translated code in cache 23 in a block tracking table 22. The translated code (TC_{F}) output from the cache 23 is executed in execution unit 13-F.

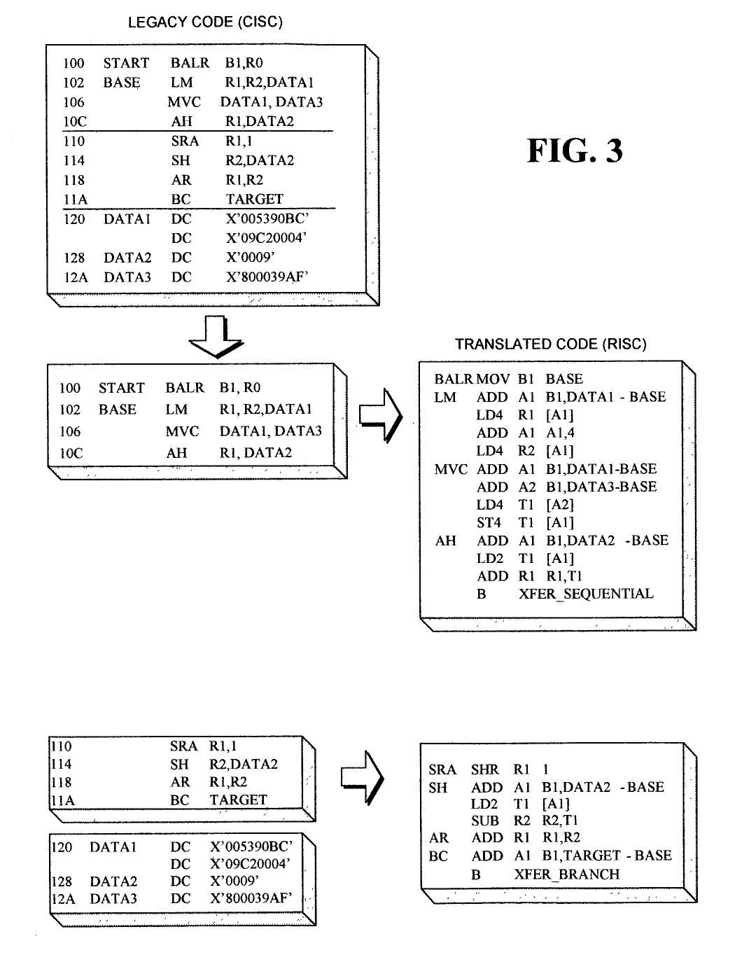

A typical example of a known emulation is illustrated in FIG. 3. In this example, legacy code is being translated to translated code where the legacy code is complex instruction set code (CISC) for a CISC architecture computer system and the translated code is reduced instruction set code (RISC) for a RISC architecture computer system. In the FIG. 3 example, the legacy code is for the S/390 architecture. In the example, the code has been simplified for purposes of clarity of explanation. The same principles apply to translations from any given architecture to any other architecture.

In FIG. 3, a typical example of CISC legacy code consists of eight S/390 instructions (with hexadecimal instruction byte addresses 100, 102, 106, 10C, 110, 114, 118 and 11A) followed by 14 bytes of operand data (with hexadecimal byte addresses 120, 128, 12A) for a total of 44 bytes. The first step in the translation is to access the legacy code blocks. In the example, there are three 16-byte aligned blocks (a first block at addresses 100, 102, 106, 10C; a second block at addresses 110, 114, 118, 11A; and a third block at addresses 120, 128, 12A). Each CISC block is translated into a block of corresponding RISC code by translating each CISC instruction in a block in order. One or more RISC instructions are required to perform the equivalent function of each CISC instruction depending on the degree of complexity of each CISC instruction.

In the example of FIG. 3, the CISC instructions BALR, SRA, and AR each require only one RISC instruction, the CISC instructions AH and SH require three RISC instructions, and the CISC instructions LM and MVC require four RISC instructions. The third CISC block (with addresses 120, 128, 12A) consists solely of operand data and does not require translation. The blocks of RISC translated code emitted from the emulation are executed by the target computer system 13-2 of FIG. 1. A transfer routine is called at the end of each RISC block to locate the next block. At the end of the first block, XFER_SEQUENTIAL is called to look up the cache location of the RISC block corresponding to the next sequential CISC address (110 in the example). The second block ends in a branch (BC), and therefore calls XFER_TARGET to perform the analogous look-up function for the CISC branch target address.

Many legacy architectures, such as the S/390 architecture, permit the program to be self-modifying, meaning that a program may store into its own code, thus altering itself dynamically during execution. Even architectures that do not directly facilitate dynamic code self-modification must still provide a means for flushing cached instructions whenever new code is loaded into memory. Under emulation, the translation cache is therefore subject to coherency requirements.

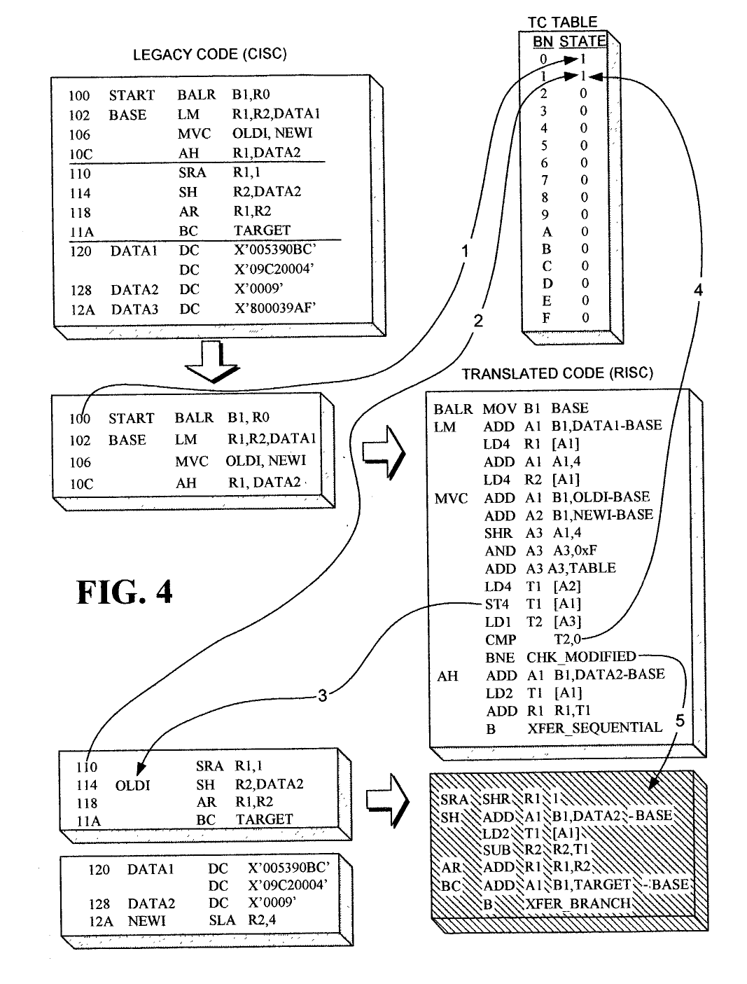

In FIG. 4, an example of just-in-time (JIT) dynamic emulation is represented where the native legacy code (LC) in object code form is translated (by translator 22 of FIG. 2), is cached (in cache 22 of FIG. 2), and executed (in execution unit 13-F of FIG. 2) a small portion at a time. The translation occurs for only a small portion of guest object code in groups that are likely to be executed next. The translation is performed in real time in the host system and is essentially concurrent with the execution of the translated code. The translated and cached code can be subsequently re-used without the need for re-translation.

In FIG. 4, the example CISC code of FIG. 3 is executed using the tracking table 23 and cache 22 of FIG. 2 in a host system 16 of FIG. 1. In operation, the host system accesses the legacy code (LC) of FIG. 4 in groups where, as in FIG. 3, there are three 16-byte aligned blocks (a first block at addresses 100, 102, 106, 10C; a second block at addresses 110, 114, 118, 11A; and a third block at addresses 120, 128, 12A). Each CISC block is translated into a block of corresponding RISC code by translating each CISC instruction in a block in order. As in FIG. 3, one or more RISC instructions are required to perform the equivalent function of each CISC instruction depending on the degree of complexity of each CISC instruction.

The groups (LC_{G}) of legacy code are presented to the legacy code translator 21. The legacy code translator 21 stores detailed information about the translation in store 24. The legacy code translator 21 also stores the executable blocks of host code in the translated code cache 23 and indexes the translated code in cache 23 in the block tracking table 22. The translated code (TC_{F}) output from the cache 23 is executed in execution unit 13-F.

In FIG. 4, the processing of store instructions differs from the processing of store instructions in FIG. 3. In FIG. 4, processing of the MVC instruction is a typical example of a store instruction that causes a store to the instruction area rather than the data area. With this operation, the old SH instruction (OLDI) generates a new instruction SLA (NEWI). The translation process in FIG. 4, unlike the process in FIG. 3, uses a block tracking table 22 (TABLE). In FIG. 4, the block tracking table tracks which CISC blocks have been translated and cached. The block tracking table 22 includes a block number index, BN, with an index range from 0ₕₑₓ to Fₕₑₓ. The size of the tracking table 22 can be expanded to allow any number of blocks to be tracked. Each block number stores a block count, STATE, indicating the number of blocks with the same index that are being translated and tracked.

The block tracking table 22 tracks a subset of all the blocks being translated and is not unique in that more than one block can be mapped to the same index in table 22. A complete map of the block translations is stored in translation store 24 of FIG. 2. The translation store 24 is much larger than tracking table 22 and typically covers the entire instruction address space of the computer system. Accordingly, the time required to search the translation store 24 is long compared with the time require to search tracking table 22. Tracking table 22, therefore, adds great efficiency to the emulation process. A detailed and time-consuming search of the large translation store 24 is avoided in those instances where no instruction data has been change by a store instruction.

In the example of FIG. 4, the portion of the CISC instruction address used to index the table 22 is taken from three hexadecimal digits (100, 102, 106, 10C, 110, 114, 118 and 11A). A subset of that portion of the address, the middle digit (shown italic), is used to address the TABLE using the BN index. Prior to commencing the translation of a group of blocks, the TABLE entries for the STATE fields for all locations from 0ₕₑₓ to Fₕₑₓ are all initialized to 0 indicating that none of the blocks in the group of blocks being tracked have been translated. When each block is translated, the contents of the corresponding TABLE entry for the STATE field is incremented by 1 to indicate that the block has been translated. Thus, in the example of FIG. 4, upon translation of the first block at address 100, the corresponding STATE field for block address index BN0 is incremented from 0 to 1. Similarly, when the second block at block address 110 is translated, the corresponding STATE field for block address index BN1 is incremented from 0 to 1. The block number indexes in the TABLE of FIG. 4 correspond to the value of their respective middle address digits (as indicated by arrows 1 and 2, respectively, for addresses BN0 and BN1).

In the table indexing method employed in FIG. 4, more than one block can map to the same TABLE entry, in which case, the contents of the STATE field entry exceeds one. The center digit and the three-digit address portion in FIG. 4 are part of a larger addressing scheme. In addition to the 16-byte block beginning at 100, the entry BN0 in the TABLE also corresponds to the blocks beginning at 000, 200, 300, and so forth on up to F00.

When a block of code is removed from the cache, then the contents of the corresponding TABLE entry in the STATE field is decremented. Thus, a value of 0 always indicates that no cached translations exist within the block address ranges of the BN index corresponding to that entry.

In the unlikely event that the number of translated blocks reaches the capacity of the TABLE entry, it then is necessary to delete a sufficient number of translated blocks to make room for any additional blocks being translated.

To permit the emulation to efficiently process self-modifying instructions, the RISC code emitted for every CISC store instruction, such as the MVC instruction in the example, includes table checking code to check the contents of the appropriate TABLE entry. As can be seen by comparing FIGS. 3 and 4, six additional RISC instructions have been added to the MVC instruction. The added instructions (SHR, AND and ADD) are used to generate the TABLE entry address for the MVC store instruction. The added instructions (LD1, CMP) are used to check the contents of the STATE field in the tracking table for the MVC store instruction. If no block is stored as indicated by a 0 in the STATE field at the index location for the block containing the store of the MVC instruction, then the translator store 24 of FIG. 1 need not be checked to determine if a change has occurred and the branch (BNE) to the CHK_MODIFIED routine is not taken. If a block is already stored at the index location as indicated by a greater than 0 in the STATE field at the index location, then the branch (BNE) to the CHK_MODIFIED routine is taken. The CHK_MODIFIED routine operates to check the translator store 24 of FIG. 2 to determine if a change has occurred.

The TABLE is checked (arrow 4 in FIG. 4) after the store has been performed (arrow 3 in FIG. 4) by execution of the CMP instruction to make sure that the translation of the victim block (the second block in this case) cannot occur after the check (CMP) but before the store (ST4). Likewise, the incrementation of the TABLE entry is done at the beginning of the block translation process (arrow 2 in FIG. 4), before the victim instruction (OLDI) has been fetched. Both of these conditions are met to insure that a potential code modification will not be missed using the tracking table 22. If a potential code modification is detected (that is, the TABLE entry is not 0), then the CHK_MODIFIED routine is called by the BNE instruction to check in the translation store 24 to determine whether any code was actually modified.

In the FIG. 4 example, for simplicity of explanation, the CISC blocks do not contain both instructions and data. In the case where a CISC block does contain both instructions and data, storing to the data portion does not constitute actual instruction code modification. In the FIG. 4 example, actual code was modified, so the victim block is invalidated (arrow 5 in FIG. 4). It is then re-translated as before, with the SLA (NEWI) having replaced the SH (OLDI).

While the invention has been particularly shown and described with reference to preferred embodiments thereof it will be understood by those skilled in the art that various changes in form and details may be made therein without departing from the scope of the invention.

1. (Original) A method for emulating execution of legacy instructions, where said legacy instructions have instruction addresses, comprising:
accessing blocks of said legacy instructions, said blocks having block addresses,
storing into a translation store translation information for each of the legacy instructions,
storing translation indications, for indicating translated blocks, into an indexing table at block numbers determined by said block addresses,
for each particular legacy instruction of a translated block having a particular block number in said table,
translating the particular legacy instruction into one or more translated instructions for emulating the particular legacy instruction,
if the particular legacy instruction is a store instruction, checking the indications in said table for said particular block number to determine if instruction data has been stored for said particular block number,
if instruction data has been stored for said particular block number, checking said translation store to determine if instruction data has been modified; and otherwise, if instruction data has not been stored for said particular block number, bypassing said checking.

2. (Original) The method of claim 1 wherein said step of storing translation indications stores indications for only a subset of all the translated blocks.

3. (Original) The method of claim 2 wherein said subset of all the translated blocks is stored in a cache.

4. (Original) The method of claim 1 wherein said step of storing translation indications uses a subset of block address digits whereby block numbers in said table are the same for multiple different blocks.

5. (Original) The method of claim 4 wherein said block address digits are included in a three digit hexadecimal address field and said subset of block address digits is the center digit.

6. (Original) The method of claim 1 wherein said legacy instructions are for a legacy system having a S/390 architecture.

7. (Original) The method of claim 1 wherein said legacy instructions are object code instructions compiled/assembled for a legacy architecture.

8. (Original) The method of claim 1 wherein said legacy instructions include store instructions for modifying instruction code.

9. (Original) The method of claim 1 wherein said translation indications include a state field for each block number indicating whether the block represented by said block number has been modified.

10. (Original) The method of claim 1 wherein,
said step of storing translation indications stores indications for only a subset of all the translated blocks and uses a subset of block address digits whereby block numbers in said table are the same for multiple different blocks,
said subset of all the translated blocks is stored in a cache,
said translation indications include a state field storing a count for each block number indicating whether the block represented by said block number has been modified,
said count in a state field is incremented each time a block represented by said block number has been modified in said cache,
said count in a state field is decremented each time a block represented by said block number has been removed from said cache,
said bypassing said checking step occurs only when said count is zero.

11. (Original) A method for dynamic emulation of object code legacy instructions, where the legacy instructions have instruction addresses determined by compilation/assembly of source code and where the legacy instructions include self-modifying store instructions for modifying instruction code, comprising:
accessing blocks of said legacy instructions, said blocks having block addresses,
storing into a translation store translation information for each of the legacy instructions,
storing translation indications, for only a subset of all the translated blocks, into an indexing table at block numbers determined by said block addresses, said storing translation indications,
using a subset of block address digits whereby block numbers in said table are the same for multiple different blocks,
including a state field storing a count for each block number indicating whether the block represented by said block number has been modified by self-modifying store instructions,
for each particular legacy instruction of said subset of all the translated blocks having a particular block number in said table,
translating the particular legacy instruction into one or more translated instructions for emulating the particular legacy instruction,
storing said translated instructions in a cache,
if the particular legacy instruction is a store instruction, checking the indications in said table for said particular block number to determine if instruction data has been stored for said particular block number,
if instruction data has been stored for said particular block number, checking said translation store to determine if instruction data has been modified; and otherwise, if instruction data has not been stored for said particular block number, bypassing said checking.

12. (Original) The method of claim 11 wherein said count in a state field is incremented each time a block represented by said block number has been modified in said cache, said count in a state field is decremented each time a block represented by said block number has been removed from said cache, said bypassing said checking step occurs only when said count is zero.

13. (Original) The method of claim 11 wherein said legacy code is compiled/assembled for a native architecture and executes as a guest on a host architecture.

14. (Original) The method of claim 13 wherein the native architecture employs CISC instructions and the host architecture employs RISC instructions.

15. (Original) A system for emulating execution of legacy instructions, where said legacy instructions have instruction addresses, comprising:
a group access unit for accessing blocks of said legacy instructions, said blocks having block addresses,
a translation store for storing translation information for each of the legacy instructions,
an index table for storing translation indications, for indicating translated blocks at block numbers determined by said block addresses,
for each particular legacy instruction of a translated block having a particular block number in said table,
to translate the particular legacy instruction into one or more translated instructions for emulating the particular legacy instruction,
if the particular legacy instruction is a store instruction, to check the indications in said table for said particular block number to determine if instruction data has been stored for said particular block number,
if instruction data has been stored for said particular block number, to check said translation store to determine if instruction data has been modified; and otherwise, if instruction data has not been stored for said particular block number, to bypass said checking.

16. (Original) The system of claim 15 wherein said index table stores indications for only a subset of all the translated blocks.

17. (Original) The system of claim 16 including a cache and wherein said subset of all the translated blocks is stored in said cache.

18. (Original) The system of claim 15 wherein said index table stores translation indications using a subset of block address digits whereby block numbers in said table are the same for multiple different blocks.

19. (Original) The system of claim 18 wherein said block address digits are included in a three digit hexadecimal address field and said subset of block address digits is the center digit.

20. (Original) The system of claim 15 wherein said legacy instructions are for a legacy system having a S/390 architecture.

21. (Original) The system of claim 15 wherein said legacy instructions are object code instructions compiled/assembled for a legacy architecture.

22. (Original) The system of claim 15 wherein said legacy instructions include store instructions for modifying instruction code.

23. (Original) The system of claim 15 wherein said index table includes a state field for each block number indicating whether the block represented by said block number has been modified.

24. (Original) The system of claim 15 wherein,
said index table stores indications for only a subset of all the translated blocks and uses a subset of block address digits whereby block numbers in said table are the same for multiple different blocks,
said subset of all the translated blocks,
said system includes a cache for storing,
said index table includes a state field storing a count for each block number indicating whether the block represented by said block number has been modified,
said count in a state field is incremented each time a block represented by said block number has been modified in said cache,
said count in a state field is decremented each time a block represented by said block number has been removed from said cache,
said bypassing of said checking occurs only when said count is zero.

25. (Original) A system for dynamic emulation of object code legacy instructions, where the legacy instructions have instruction addresses determined by compilation/assembly of source code and where the legacy instructions include self-modifying store instructions for modifying instruction code, comprising:
a group access unit for accessing blocks of said legacy instructions, said blocks having block addresses,
storing into a translation store for storing translation information for each of the legacy instructions,
an index table for storing translation indications, for only a subset of all the translated blocks at block numbers determined by said block addresses, said index table storing translation indications,
using a subset of block address digits whereby block numbers in said table are the same for multiple different blocks,
including a state field storing a count for each block number indicating whether the block represented by said block number has been modified by self-modifying store instructions,
a legacy code translator operating for each particular legacy instruction of said subset of all the translated blocks having a particular block number in said table,
to translate the particular legacy instruction into one or more translated instructions for emulating the particular legacy instruction,
To store said translated instructions in a cache,
if the particular legacy instruction is a store instruction, to check the indications in said table for said particular block number to determine if instruction data has been stored for said particular block number,
if instruction data has been stored for said particular block number, checking said translation store to determine if instruction data has been modified; and otherwise, if instruction data has not been stored for said particular block number, to bypass said checking.

26. (Original) The system of claim 25 wherein said count in a state field is incremented each time a block represented by said block number has been modified in said cache, said count in a state field is decremented each time a block represented by said block number has been removed from said cache, said bypassing said checking step occurs only when said count is zero.

27. (Original) The system of claim 25 wherein said legacy code is compiled/assembled for a native architecture and executes as a guest on a host architecture.

28. (Original) The system of claim 27 wherein the native architecture employs CISC instructions and the host architecture employs RISC instructions.
